(19) United States
(12) Patent Application Publication
(10) Pub. No.: US 2003/0135773 A1
(43) Pub. Date: Jul. 17, 2003

(54) Remote sensing of power supply states

(76) Inventors: Song Zhang, Naperville, IL (US); Mazhar Mohiuddin, Hoffman Estates, IL (US); Phillip Kent Freyman, Elgin, IL (US); Nolan Schiebout, W. Dundee, IL (US); Kathleen E. Ashe, Carol Stream, IL (US); Rainu Pierce, Barrington, IL (US); Michael Beruscha, Algouquin, IL (US); Mark A. Harris, Elk Grove Village, IL (US); Annette J. Schiebout, West Dundee, IL (US)

Correspondence Address: MOTOROLA, INC., 1303 EAST ALGONQUIN ROAD, IL01/3RD, SCHAUMBURG, IL, 60196

(21) Appl. No.: 10/047,141

(22) Filed: Jan. 15, 2002

(51) Int. Cl. G06F 1/26

(52) U.S. Cl. 713/340

(57) ABSTRACT

Power supplies (116) for cable access units (110) have associated backup power supplies (120) and generate one or more power supply status indications for said backup power supplies (120). Cable access units (110) monitor and retain the generated power supply status indications. An operator unit (102) communicates periodically with the cable access units (110) to ascertain the power supply status indications. If any power supply status indications indicate an alarm condition, the operator unit (102) can display an indication of the alarm condition and the identity of the cable access unit reporting the alarm condition. Alternatively, if the number of reported alarm conditions equals or exceeds a service area alarm threshold, the operator unit (102) can display a service area alarm in lieu of displaying any individual alarms.

### FIELD OF THE INVENTION

The present invention relates to power management in networks, and more particularly to remote headend monitoring of power supply status information on customer premises.

### BACKGROUND OF THE INVENTION

Cable telephony networks link multiple cable access units which provide delivery of one or more of telephony, data, video programming, or other broadband services to end users. Commercial utility power is commonly used to power the cable access units wired into the network.

In a cable telephony communication system, for example, a cable access unit (CAU) is a broadband telephony interface used to deliver broadband Internet, data, and/or voice access jointly with telephony service to a subscriber's or customer's premises using a cable network infrastructure. The CAU is normally installed at the subscriber's premises, and it is coupled to an operations and maintenance center (OMC), generally by using a HFC (hybrid fiber coax) cable access connection. The CAU end user communication devices primarily are premises powered at the subscriber's location, and thus the availability and power status of a premises-based power supply is a critical concern in cable telephony-based communication systems, or the like.

Various problems can occur with the supply of power to a cable access unit which include failure of the commercial utility power source providing power to the cable access unit. Failure of the commercial utility power source has been previously addressed by (1) reliance on a shared backup power source located on the premises of the network service provider which is monitored and managed by network provider operators, or (2) use of backup power supplies provided on the subscriber's premises which are managed at the subscriber's premises. Backup power supplies such as backup batteries, however, are typically only able to provide backup power for temporary periods of time until their storage of power has been depleted.

In order to maintain a cable telephony system in operation, it is necessary for the network operators to have information regarding the status of backup power supplies located at the customer's or subscriber's premises. In these prior arrangements, the telephony system operators and the like did not have any indication that the main power had been lost (and thus that the backup power was on), or that the backup power may be approaching the end of its capacity without notification by the customer or subscriber or a physical visit by system technicians or the like to the customer or subscriber premises.

Accordingly a need has existed for the capability to effectively provide telephony system operators and the like with indications of the backup power supply status for those cable access units with which the users are interacting.

### BRIEF DESCRIPTION OF THE DRAWINGS

FIG. 1 shows two devices connected through a cable telephony network;

FIG. 2 shows an embodiment of an algorithm for control of a cable control unit;

FIG. 3 shows an embodiment of an algorithm for monitoring alarm conditions;

FIG. 4 shows an embodiment for monitoring alarm conditions for a plurality of cable access units within a given service area;

FIG. 5 shows an embodiment for executing the telemetry signaling used in the practice of the invention;

FIG. 6 shows one embodiment of an algorithm for asserting a power supply alarm;

FIG. 7 shows one embodiment of an algorithm for asserting a power supply alarm; and

FIG. 8 shows one embodiment of an algorithm for asserting a power supply alarm.

### DETAILED DESCRIPTION OF THE DRAWINGS

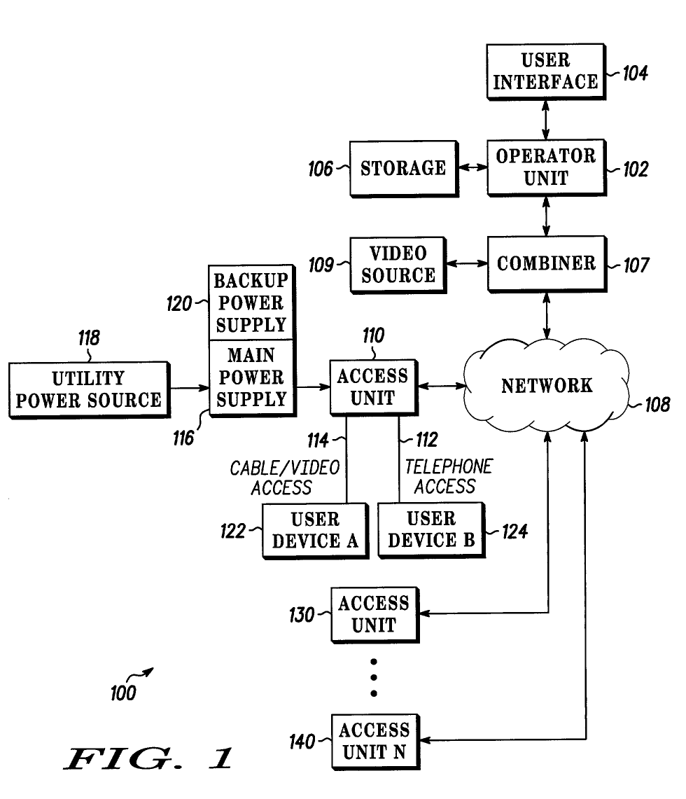

Referring to FIG. 1, shown are two devices connected through a cable telephony network. A cable telephony network is described for sake of illustration, and it will be appreciated that the invention has applicability in other related communication networks or communication distribution networks.

Together, the operator unit 102, the user interface 104, the storage 106, combiner 107, and video source 109 comprise a headend. A headend is generally a central device or location in a network which provides centralized functions for signal modification. The operator unit 102 communicates with the cable access unit 110 located on a subscriber premises, and acts as a protocol converter from a cable plant to an end office exchange.

System 100 includes the operator unit 102 or some other base communications unit that is connected to subscribers via access units 110, 130, 140, and so forth by a distribution network 108 and a combiner 107. Combiner 107 has an input for video source 109. Operator unit 102 also includes cable port transceivers (not shown) which are connected to combiner 107. The cable port transceivers generate downstream carrier channels in communications system 100. Combiner 107 receives modulated RF channels from video source 109 and from operator unit 102 and sums these together to be sent over distribution network 108.

In an embodiment of the present invention, telemetry is used to make information available to the operations and maintenance center (OMC) staff via the user interface 104 regarding the operability and power status of cable access units on customer premises. This information includes the operational status of a backup power supply 120, and may comprise whether a backup battery is in operation, whether a battery backup has a low or depleted capacity, and whether a battery backup is missing (e.g. disconnected).

The user interface 104 at the headend in this illustration is a software visual display presented on a hardware device such as a display or monitor. User interface 104 is the visual display for operator unit 102 and facilitates user interaction and use of operator unit 102. In an embodiment, user interface 104 is a graphical user interface (GUI), but can be any form of suitable interface. The storage 106 is also coupled to operator unit 102 and serves as a memory or storage for use by the software running on operator unit 102. The connections between operator unit 102, network 108, and cable access unit 110 are telecommunications connections such as, but not limited to, wired connections (e.g. twisted copper or fiber optic) or wireless connections (e.g. cellular, satellite, Bluetooth, or any other radio frequency-based approach). One embodiment for network 108 is a hybrid fiber/coax (HFC) network, but any network permitting communication may be used.

In general, cable access unit 110 is located at or near the user's premises, and, in this illustration, separates telephony from video signals on the downstream path and injects telephone signals (and interactive cable signals in an interactive cable system) into the upstream path. The cable access unit 110 can feature standard screw interface connectors for conventional telephones and standard coaxial connections for the cable interface. The cable access unit 110 has both a telephone access line 112 by which voice and other telephonic communication is enabled, and a cable/video access line 114 by which video and audio transmission is enabled. User device A 122 is coupled to cable/video access line 114 and receives video or other cable-provided services and/or communicates with cable access unit 110. User device A 122 can be any device such as, but not limited to, a television, a computer, or a set-top box. User device B 124 is coupled to connection 112 and communicates with cable access unit 110. User device B can be any device such as, but not limited to, a telephone, fax machine, or an answering machine. Cable access unit 110 is powered from the main power supply 116, but is also coupled to the backup power supply 120. Main power supply 116 normally provides the power required by cable access unit 110 to function. Backup power supply 120 serves as the power source for cable access unit 110 whenever main power supply 116 ceases supplying power to cable access unit 110. The backup power supply 120 can be any device such as, but not limited to, a battery, a solar energy system, or a generator. Generally, however, the backup power supply 120 has only a limited capacity and thus cannot indefinitely supply power to the cable access unit 110 in case of main power supply 116 failure. The utility power source 118 serves as the power source for main power supply 116.

A common cause of main power supply 116 failure is as a direct result of the failure of utility power source 118, which is typically commercial utility power. When such a failure occurs, backup power supply 120 switches in and begins providing power to cable access unit 110. As discussed previously, backup power supply 120 has only a finite reserve capacity and thus is only able to power cable access unit 110 for a finite period of time which varies with the level of reserve capacity of backup power supply 120 and with the power requirements of cable access unit 110. The power requirements of cable access unit 110, in turn, vary with the actual physical embodiment used for cable access unit 110 as well as the operational demands being made on cable access unit 110. As cable access unit 110 will cease operation whenever backup power supply 120 fails (provided that main power supply 116 has not resumed operation), there is a need for a way by which network technicians, network operators, or the like are informed of the real-time status information on the reserve capacity of backup power supply 120. This status information of backup power supply 120 can include, but is not limited to, whether backup power supply 120 is supplying power to cable access unit 110 (indicating main power supply loss), whether backup power supply 120 has a reserve capacity below a low power threshold, whether backup power supply 120 has no reserve capacity, whether backup power supply 120 has failed or needs replacement, and whether backup power supply 120 is missing (e.g. disconnected or uncoupled from the main power supply 116 and/or access point 110). In order to get the desired status information, operator unit 102 initiates communication over network 108 to cable access unit 110 requesting a status update. In an embodiment, the status of backup power supply 120 is provided by alarm conditions which are generated by power supply 116 regarding the power status of backup power supply 120 at predefined alarm addresses (also herein called locations) which in one embodiment are physical hardware locations on power supply 116. Each alarm condition is only asserted if its respective predetermined event occurs.

In order to maintain a cable telephony system, for example, it is necessary to have information about certain states that indicate satisfactory operation of cable access units and the associated power and radio frequency distribution network. The present embodiment obtains this data through telemetry from the headend and provides this data to network operators through an element manager, which is a program or part of the user interface 104. This information includes the operational status from power supplies which includes the status of the backup power supplies such as whether any backup power supplies are operating, if any backup power supply capacity is low, and whether any backup power supplies are missing.

Remote sensing of power supply states allows a system operator to monitor premises power supply signals and be alerted when premises power supply problems occur on those cable access units (CAUs) 110 having power supplies 116 equipped with the telemetry feature. A premises power supply, such as model APC TL14U48 (available from American Power Conversion (APC) Corp.), is powered by house current and includes backup battery capability. There are three alarm classes for which a premises power supply such as the APC TL14U48 generates alarm conditions, and which are thereafter detected by the cable access unit 110 (CAU) and alerted to the operator via alarms:

1) the on-battery alarm which is asserted if the utility power (house current) is missing at the sampling time;

2) the battery-missing alarm which is asserted if the battery is disconnected at the sampling time; and

3) the replace-battery alarm which is asserted it the battery is in a failed state at the sampling time.

In an embodiment, the system 100 takes snapshots of the current state of the three physical input signals of the premises power supply as reported by the respective cable access unit 110. This is obtained by periodically pinging the cable access unit 110. If any of the three alarm conditions exist at the sampling time, the main power supply 116 will generate a signal state change from normal state to alarm state (referred to herein as asserting) on the corresponding input line to the cable access unit 110. When the alarm condition has cleared, the premises power supply will generate a signal state change from alarm state to normal state (referred to herein as deasserting or unasserting) in the corresponding signal. If the system 100 has detected that an alarm condition exists at the sampling time, it will generate an individual cable access unit 110 alarm for the corresponding premises power supply signal. The system 100 will clear an individual cable access unit 110 premises power supply alarm when it detects that the alarm condition is cleared during a subsequent sampling time.

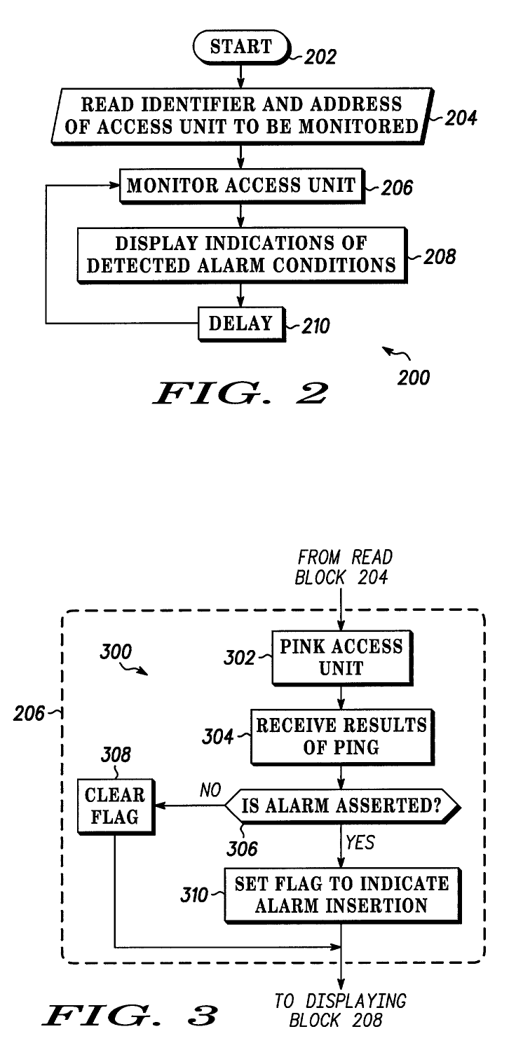

Referring to FIG. 2, shown is an exemplary algorithm 200 representing one embodiment for software control of operator unit 102. The algorithm 200 checks whether any alarm conditions have been asserted by the backup power supply 120 associated with cable access unit 110 and displays any detected alarm conditions for the operator.

In operation, the algorithm 200 starts 202, accesses the storage 106, and reads 204 the identity and address of the cable access unit 110 to monitor. Alternatively, operator unit 102 can obtain the identity and address of cable access unit 110 to be monitored from other means, such as, but not limited to, input by an operator or the accessing of a remote database. The algorithm 200 then monitors 206 the identified cable access unit 110.

Various mechanisms exist by which operator unit 102 can effect monitoring. As an embodiment, monitoring is carried out by “pinging”. Pinging a cable access unit 110 generally constitutes the sending of a small specific message to the device. This ping message is carried by the network 108 transport protocol. If the cable access unit 110 is in proper operation and receives the ping message, it generates a reply message. This reply message will contain an indication of whether the cable access unit 110 is telemetry capable, and if so, it will contain the status information which will include any alarm conditions reported. The reply message is also carried by the network 108 transport protocol.

After receiving the reply message, algorithm 200 stores the message (as shown in greater detail in reference to FIG. 3) then displays 208 an indication of at least one detected alarm condition in the event that any were reported in the reply message. The indication displayed can take many forms such as, but not limited to, a visual display (such as a pop-up window or text message), an audio indication (such as a voice message or other audible audio indication), tactile indication (such as by a force-feedback input device), or any combination of the preceding. Algorithm 200 then delays 210 before returning and again monitoring 206 the cable access unit 110 and continuing as previously discussed. Thus a loop is formed consisting of blocks 206, 208, and 210 which continually keeps the operator unit 102 updated with correct alarm statuses. The exact length of delay can be varied depending on the needs of the specific implementation, or alternatively, the delay can be omitted.

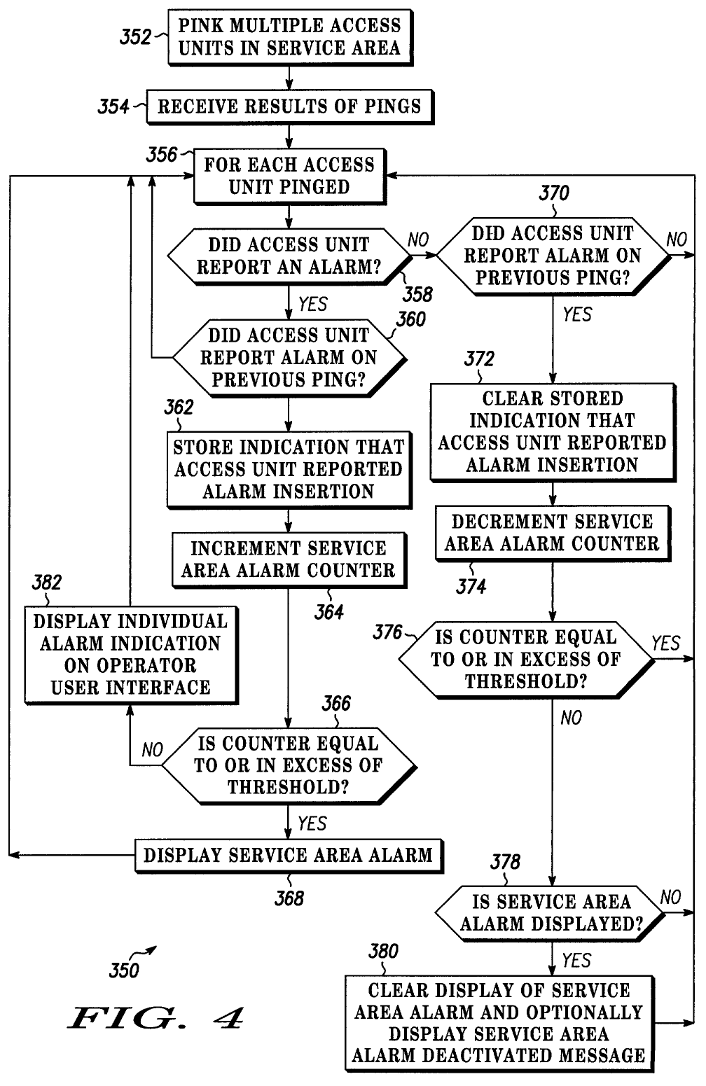

Referring to FIG. 3, shown is an exemplary algorithm 300 representing one embodiment for block 206 of FIG. 2 for monitoring and storing the alarm conditions of cable access unit 110. For the sake of simplifying the discussion, FIG. 3 treats the situation of monitoring one access unit for only one alarm condition and only ensures that the alarm flag is set when the alarm condition is asserted. FIG. 4, discussed later herein, shows an example of a service area wide application over multiple cable access units 110 of the concepts of this embodiment. FIG. 4 also includes the asserting and deasserting of alarm flags based on both current reported alarm conditions and past reported alarm conditions.

Algorithm 300 continues from the “read identifier and address of access unit to be monitored” block 204 shown in FIG. 2 and pings 302 the access unit to request a status report.

Pinging, as discussed previously herein, generally consists of sending a small, specific message to the network address at which a cable access unit 110 resides. If the pinged cable access unit 110 is present, functioning, and the network connection to the physical location of that address is intact, the pinged cable access unit 110 will receive the ping and reply back to the sender, thereby indicating it is online and operating. The algorithm 300 next receives 304 any ping reply message. In one embodiment, algorithm 300 monitors for a reply message from the ping only for a defined timeout period. Should the timeout period expire without a message being received, then algorithm 300 will determine that a problem exists either in the connection to cable access unit 110 or that the cable access unit 110 itself is down. Algorithm 300 may have alternative code which, when executed, runs other tests to determine whether a network connection problem has developed, and if so, to appropriately notify operator unit 102 and, if desired, display a notice on user interface 104.

Next, the algorithm 300 determines 306 from the received return message whether the cable access unit 110 pinged indicated an alarm condition. If no alarm condition was asserted, algorithm 300 clears 308 the alarm flag and then continues to display block 208.

If an alarm condition has been asserted, algorithm 300 sets 310 a respective flag to indicate the alarm condition has been asserted at the pinged cable access unit 110. Each independent cable access unit 110 which is monitored is given a respective alarm flag. As used herein, setting a flag simply means that algorithm 300 stores an indication that an asserted alarm condition has been detected.

After setting the alarm flag, algorithm 300 continues to the display block 208 shown in FIG. 2 where, as previously described herein, at least one of the alarm conditions detected is displayed on the user interface 104.

In the monitoring of alarm conditions as carried out in the algorithms 200 and 300 of FIGS. 2 and FIG. 3, illustrated is the monitoring of one cable access unit 110 at a time. The algorithms 200 and 300 described herein are capable of being implemented in either hardware, software, or both.

In addition to the monitoring of only one access point 110 at a time, it is noted that monitoring of multiple cable access units 110 can be done in parallel by executing the loop consisting of blocks 206, 208, and 210 separately for each cable access unit 110 to be monitored. Alternatively, multiple cable access units 110 can be pinged and the reply messages collected separately but substantially simultaneously (in either series or parallel) in the “monitor access unit” block 206 and then the collective results displayed at block 208, and thus results from all cable access units monitored are produced during one cycle of the loop consisting of blocks 206, 208, and 210.

In one embodiment, a service area alarm will be generated instead of an individual cable access unit 110 alarm when the percentage of cable access units 110 in a service area reporting an alarm condition for a particular alarm class is equal to or has exceeded either a middle or high provisional threshold for that alarm class. Provisional thresholds are predetermined count levels against which actual numbers of cable access units 110 reporting an alarm condition can be compared in order to determine whether the operator unit 102 must do something. In an embodiment, three thresholds, low, medium, and high, having a predetermined count at what constitute, respectively, a low level emergency, a medium level emergency, and a high level emergency are used. A service area alarm is cleared when the percentage of cable access units 110 in a service area reporting the corresponding alarm condition has decreased to a value equal to the provisional low threshold. When a service area alarm for an alarm class has been generated, individual cable access unit 110 alarms for that alarm class are no longer generated. Prior existing individual alarms continue to be displayed in the service area until the service area alarm clears. The element manager will process all alarm requests and present them in an alert window, track alarms in an element manager log and generate alarms to the user interface 104. The alert window is a graphical user interface (GUI) window that displays alarm notifications. The element manager log is a database file that records events including the alarms so that management reports or system analysis can be performed offline such as at a later time. These features are generally provided by means of automated pinging. The periodicity of the sampling discussed above is the same as the time interval defined for automated pinging. It is important to note that for this feature to work properly and present up-to-date information regarding the power supply status, automated pinging must remain enabled. Manual pings, which are user-instigated rather than timed, to cable access units 110 having premises power supplies by a network operator will also generate and clear alarms.

In an embodiment, only alarm conditions reported for the on-battery alarm class are counted and a service area alarm is only generated for the on-battery alarm class. Further, as discussed previously herein in an embodiment, three thresholds representing low, medium, and high emergency levels are used in determining whether to generate a service area alarm for the on-battery condition.

Referring to FIG. 4, shown is an exemplary algorithm 350 for service area monitoring by the operator unit 102.

The operator unit 102 is able to ping and thus receive telemetry information from all the telemetry-capable cable access units 110 in its service area. After determining the alarm status of all of the telemetry-capable cable access units 110 in operator unit 102's service area, the operator unit 102 then analyzes the acquired information to determine whether a multi-access unit problem is in progress. In an embodiment, the operator unit 102 maintains three flags for each alarm class of each telemetry-capable cable access unit 110. These flags are the alarm flag, the alarm_previously_asserted flag, and the clear_previously_asserted flag. In an embodiment, the alarm classes monitored include, but are not limited to, whether the backup power supply is supplying power, whether the backup power supply is at a low reserve capacity, and whether the backup power supply is disconnected or failed. In operation, the operator unit 102 periodically surveys all telemetry-capable cable access units 110 in its service area to determine the power supply status of each cable access unit 110.

Generally, an operator unit 102 is connected to a plurality of cable access units 110 which, collectively, make up a “service area”. In operation, algorithm 350 begins by pinging 352 one or more cable access units 110 connected to it. The order of pinging is variable and can be implemented in a variety of ways such as in parallel, in series, in bursts of one or more at a time, and so forth. Next, the algorithm 350 waits and receives 354 the replies from the pings. There is no requirement that the results be received in any order and, indeed, the order of receipt of the results from the cable access units 110 need not be in the order in which the cable access units 110 were pinged. Similar to the description in reference to FIG. 3, each cable access unit 110 is generally given a timeout period for responding to a ping. If no response is received by the expiration of a timeout period, the network connection to that cable access unit 110 or that cable access unit 110 itself may have a problem.

Once ping reply messages are received, the algorithm 350 must process each reply message. Thus a “For each access unit pinged” block 356 indicates that the operator unit 102 carries out the steps discussed hereafter for each cable access unit 110 pinged which sends back a reply message. In processing a reply message, the algorithm 350 analyzes the ping reply message from one cable access unit 110 (hereafter referred to as the current cable access unit 110) to determine 358 if an alarm was reported. If an alarm was reported, the algorithm 350 determines 360 if the current cable access unit 110 reported the same alarm on the previous (i.e. prior) ping by checking the alarm_previously_asserted flag for that cable access unit 110. If the current cable access unit 110 did report the same alarm on the previous ping, then that alarm was already logged and the algorithm 350 continues back to block 356 to process a reply message from another cable access unit 110.

If the current cable access unit 110 did not report the same alarm on the prior ping, the algorithm 350 stores 362 an indication of the alarm by setting the alarm flag for that cable access unit 110 and also sets the alarm_previously_asserted flag for that cable access unit 110. Next, the algorithm 350 increments 364 a service area alarm counter which keeps track of the number of cable access units 110 in the service area reporting the alarm. Next, the algorithm 350 determines 366 if the service area alarm count equals or exceeds a predetermined threshold. If the service area alarm count does not exceed the threshold, a service area alarm is not warranted and the algorithm 350 displays 382 an individual alarm indication for the current cable access unit 110 and continues back to the “For each access unit pinged” block 356 to process another reply message. It is noted here that there may already be one or more prior individual cable access unit 110 alarm indications displayed for other cable access units. If the service area alarm count equals or exceeds the threshold, the algorithm 350 displays 368 a service area alarm and continues back to the “For each access unit pinged” block 356 to process another reply message.

It is noted that in an embodiment, once a service area alarm is displayed, no further individual cable access unit 110 alarms will be displayed until the service area alarm count falls below the threshold and the service area alarm is cleared. It is noted also that this embodiment discusses only one threshold, but other embodiments contemplate the use of more than one threshold for service area alarms. In an embodiment, three thresholds, having a predetermined count at what constitute a low level emergency, a medium level emergency, and a high level emergency would be used.

It is further noted that this embodiment only discusses the monitoring of one generic alarm condition, but other embodiments can have multiple alarms. In an embodiment, the three conditions of backup power supply supplying power to the cable access unit 110, backup power supply disconnected from main power supply, and backup power supply inoperable (i.e. failed or needing replacement) are monitored for each responsive cable access unit 110, but only the alarm condition of backup power supply supplying power to the cable access unit 110 (i.e. the on-battery alarm) would be counted and compared against thresholds to produce service area alarms.

If a reply message does not have an alarm asserted in the determination of block 358, the algorithm 350 determines 370 if the current cable access unit 110 reported an alarm on the previous ping. If not, the algorithm 350 continues back to the “For each access unit pinged” block 356 to process another reply message.

If an alarm was reported on the previous ping, the algorithm 350 clears 372 the stored indication (the alarm_previously_asserted flag) that the current cable access unit 110 previously reported an alarm and decrements 374 the service area alarm count. Next, the algorithm 350 determines 376 if the service area alarm count still equals or exceeds the threshold. If the service area alarm count does still equal or exceed the threshold, nothing further needs to be done for the current cable access unit 110 and the algorithm 350 continues back to the “For each access unit pinged” block 356 to process another reply message.

If the service area alarm count is less than the threshold, the algorithm 350 determines 378 if the service area alarm is displayed and if so, clears 380 the service alarm display. Optionally, the algorithm 350 can display a service area alarm cleared message to inform the operator that the alarm has been cleared. Thereafter, or if the service area alarm is not displayed, the algorithm 350 continues back to the “For each access unit pinged” block 356 to process another reply message.

In an embodiment, the operator unit, after incrementing any service area count, compares this count with a service area alarm gauge for that alarm class. The service area alarm gauge is a set of one or more thresholds which define different levels of concern. As discussed previously, in an embodiment, thresholds are set for low, medium, and high emergency levels. Thus, when a service area count is found to equal or exceed a service area alarm gauge threshold, the respective alarm emergency level is displayed or otherwise made known to operations and maintenance center (OMC) personnel for their attention and response thereto.

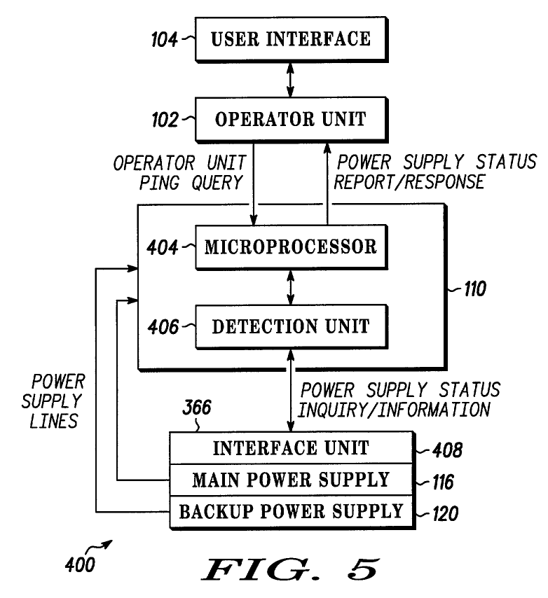

Referring to FIG. 5, shown is an example of one embodiment of telemetry use.

In operation, the backup power supply 120 is closely coupled to the main power supply 116. In an embodiment, the backup power supply 120 is integral to the main power supply 116 although there is no requirement that this be so. The main power supply 116 monitors the power status of the backup power supply 120. In an embodiment, main power supply 116 monitors at least one of the following: whether the backup power supply is supplying power to the cable access unit 110, whether the backup power supply is disconnected or non-responsive to the monitoring of the main power supply 116, and whether the backup power supply 120 is determined to need replacing or to have failed. Any conditions desired, however, can be monitored within the scope of the present invention. In an embodiment, the monitoring by main power supply 116 is continuous, but other embodiments, such as, but not limited to, periodic monitoring or monitoring in response to a request from the operator unit 102 are within the scope of the present invention. As main power supply 116, in an embodiment, continually monitors backup supply 120, main power supply 116 always has up-to-date status information on backup power supply 120 and this information is presented by main power supply 116 at an interface unit 408. In an embodiment, interface unit 408 is a physical connector used to couple the power supplies to the access unit 110.

The cable access unit 110, comprising a microprocessor 404 and a detection unit 406, monitors the interface unit 408 of the main power supply 116 to ascertain the status of the backup power supply 120. This monitoring is carried out by the detection unit 406. In an embodiment, the monitoring by the detection unit 406 is continuous, but other embodiments, such as, but not limited to, periodic monitoring or monitoring in response to a request from the operator unit 102 are within the scope of the present invention. The detection unit 406 maintains the status information on backup power supply 120 for any eventual request by the microprocessor 404. In an embodiment, the detection unit 406 would be hardware implemented, but embodiments wherein the detection unit 406 comprises software running on a processor or other software/hardware hybrids are within the scope covered by the present invention.

At the headend, operator unit 102, automatically or at the manual initiation of a network operator, initiates a status inquiry of cable access unit 110 by sending a ping query to cable access unit 110 (shown as “operator unit ping query”). This ping query is received by the microprocessor 404, which responds by requesting the status information from the detection unit 406. As discussed previously herein in reference to FIG. 5, the detection unit 406 maintains up-to-date copies of the backup power supply 120 status and so it is able to respond to the request from the microprocessor 404. The microprocessor 404, upon receiving the status information from the detection unit 406, forms the status information into an appropriate signal and sends it to operator unit 102 (shown as “power supply status report/response”). The operator unit 102 then analyzes the received status information to determine whether the cable access unit 110 is telemetry capable, and if so, what the status information is regarding the backup power supply 120. If the status information indicates an alarm condition, the operator unit 102 may display either an individual alarm or a service area alarm. An exemplary algorithm describing one way operator unit 102 can do this is discussed in detail with respect to FIGS. 2, 3A, and 3B presented previously herein.

It is noted that some cable access units 110, particularly legacy equipment, are unable to respond to telemetry inquiries. Such cable access units 110 will therefor either not respond to a ping query, or will respond without providing the status information on backup power supply 120. In such cases, the operator unit 102, in analyzing the ping response from the cable access unit 110, will ascertain that the cable access unit 110 is not telemetry-capable and so will be unable to determine if any alarm conditions exist for that cable access unit 110.

By way of one non-limiting example one particular embodiment of the present invention utilizes an APC TL14U48 power supply, a commercial power supply capable of providing telemetry output signals for remote sensing of power supply states. Telemetry signaling is done open-collector style by the APC TL14U48 power supply. APC TL14U48 pin #3 (VCC) provides power that can be used to drive transistors. The VCC voltage is an unregulated voltage ranging from 10 vdc to 17 vdc. It is current limited to approximately 85 mA.

Telemetry signaling in the illustrated power supply is as follows:

TABLE 1

| pin number | signal | transistor closed indicates | transistor open indicates |
|---|---|---|---|
| 4 | on-battery | commercial power failed | commercial power present |
| 5 | battery-present | battery is present | battery not present (battery |
| | | | disconnected) |
| 6 | replace-battery | battery failed | battery is ok |

The cable access unit 110 hardware will detect the three alarm conditions that the premises power supply generates and present it to the microprocessor, such as a Motorola MC68LC302, through general-purpose I/O port A. The port I/O pin 3, pin 4, and pin 5, are connfigured as an input when corresponding PADDR (physical address) bit is cleared. The pins PA3, PA4, and PA4 are used to present to the microprocessor the current state associated with the on-battery, battery-present, and replace-battery status signals. A logic low or high indicates to the cable access unit 110 software that the associated premises power supply signal is in the normal or alarm state respectively. The pin PA6 of MC68LC302 microprocessor is provided to indicate if the cable access unit 110 hardware is capable of monitoring the status of premises power supply signals. When PA6 is in a logic low state, the cable access unit 110 is telemetry capable. When PA6 is in a logic high state, the cable access unit 110 is not telemetry capable. Four 3-state buffers are placed in front of PA3, PA4, PA5, and PA6 pins to protect the output transistors in the situation when incompatible software is loaded. Buffers will only allow the three telemetry signals to pass through when compatible software is loaded and PA6 is configured as an input pin. By inverting the transistor logic for the on-battery and replace-battery signal lines, the cable access unit 110 is able to provide normal states when under coaxial power or the like. Tables 2 and 3 summarize the normal and alarm states for three status signals in the illustrated power supply and microprocessor.

TABLE 2
Power Supply

| pin number | signal | normal state | alarm state |
|---|---|---|---|
| 4 | on-battery | transistor open | transistor closed |
| 5 | battery-present | transistor closed | transistor open |
| 6 | replace-battery | transistor open | transistor closed |

TABLE 3
Microprocessor

| pin number | signal | normal state | alarm state |
|---|---|---|---|
| PA3 | on-battery | high | low |
| PA4 | battery-present | high | low |
| PA5 | replace-battery | high | low |

When the cable access unit 110 powers up, the cable access unit 110 software looks at pin PA6 of the MC68LC302 microprocessor to determine if the cable access unit 110 hardware is capable of monitoring the status of the premises power supply signals. If the cable access unit 110 hardware detects that it is able to monitor the three physical input lines for the on-battery, battery-missing, and replace-battery signals from the premises power supply, it sets pin PA6 of the MC68LC302 microprocessor to logic low. Otherwise, it sets pin PA6 to logic high. The cable access unit 110 software also uses pins PA3, PA4, and PA5 on the MC68LC302 microprocessor to sample the current state associated with the on-battery, battery-missing, and replace-battery status signals from the premises power supply. A logic low on these pins indicates to the cable access unit 110 software that the associated premises power supply signal is in the alarm state (i.e. there is an alarm condition). A logic high indicates to the cable access unit 110 software that the associated premises power supply signal is in the normal state.

The cable access unit 110 only reports the status information associated with the on-battery, battery-missing, and replace battery signals when it is pinged by the operator unit 102. When the cable access unit 110 is pinged, it first checks if it is capable of monitoring the main power supply 116 states and if it is, it looks at pins PA3, PA4, and PA5 to determine the current state associated with the on-battery, battery-missing, and replace-battery signals. The cable access unit 110 then reports the signal current state information in the ping response message to the operator unit. If the cable access unit 110 hardware is not capable of detecting main power supply 116 states, the cable access unit 110 software does not send the signal current state information in the ping response to the operator unit 102.

The operator unit 102 will use the ping results from the cable access unit 110 as stated previously herein to determine the current state associated with the on-battery, battery-missing, and replace-battery main power supply 116 signals. When the ping response comes back from the cable access unit 110, the operator unit 102 first looks to see if the telemetry feature is enabled. Control of whether alarm reporting is on (i.e. enabled) or off (i.e. disabled) is generally under the control of the user. If the telemetry feature is disabled, the operator unit 102 does not process the status information for the three main power supply 116 signals and therefore does not generate any alarms. If the telemetry feature is enabled, the operator unit 102 looks at the status information for the three main power supply 116 signals in the ping response to determine the current state associated with each one of the signals. If the current state of a main power supply 116 signal is in the alarm state, the operator unit checks whether the same power supply signal was in the normal state on the previous ping query, and if this is true, it generates an individual cable access unit 110 alarm associated with that main power supply 116 signal. If the on-battery signal is in the alarm state and was in the normal state on the previous ping query, an individual cable access unit 110 alarm will only be generated if the service area alarm is not active. If a main power supply 116 signal is in the normal state which was in the alarm state on the previous ping query, the operator unit 102 will clear the individual cable access unit 110 alarm associated with that signal.

The operator unit 102 keeps a counter, in another embodiment, in a service area, of the number of cable access units 110 reporting the on-battery alarm condition. The counter will be incremented each time a cable access unit 110 reports an on-battery alarm condition. The counter will not be incremented for a cable access unit 110 reporting an on-battery alarm condition which was already reported on the previous ping. The counter is decremented when a cable access unit 110 reports that the on-battery alarm condition has cleared. The counter is not decremented when the cable access unit 110 reports an alarm has cleared which that cable access unit 110 had reported in a previous ping and in response to which the counter already was decremented.

The operator unit 102 will support a service area gauge that will specify the high, middle, and low thresholds (also called gauge thresholds) used for determining when the on-battery service alarm should be generated with the associated severity. The on-battery service alarm is generated in high, middle, and low severities corresponding to when the number of cable access units reporting the on-battery alarm exceeds the high, middle, and low gauge thresholds, respectively. These severities are also referred to as provisioned severities and refer to the level of the alarm generated. If the service area gauge has been created and enabled for the service area, the operator unit 102 will compare the gauge thresholds with the percentage of cable access units 110, 130, 140, and so forth in the service area reporting the on-battery alarm condition to determine if a threshold has been crossed. The percentage is calculated by taking the service area counter for the number of cable access units 110, 130, 140, and so forth reporting the on-battery alarm condition, and dividing this by the total number of enabled cable access units in the service area. If a gauge threshold has been crossed, a service area alarm will be generated with the provisioned severity. The alarm is a threshold crossing alert reported by the gauge. Individual cable access unit 110 alarms for the on-battery alarm condition are no longer displayed once this alarm is displayed. On-battery alarms against cable access units that had previously been emitted will not be affected by this alarm. A service area alarm is automatically cleared when the gauge's low threshold is crossed when the number of cable access units 110 reporting an on-battery alarm falls below the low threshold.

The gauge associated with the on-battery service area alarm must be created and provisioned in order for a service area alarm to be generated. If the gauge is not created, the system generates a flood of individual cable access unit 110 on-battery alarms instead of a single on-battery service area alarm when power outage effects a large area.

The present embodiment offers at least the following advantages:

1) It uses telemetry to make remote information available to operation and maintenance center (OMC) staff in a cable telephony system (the operation and maintenance center functions in part to detect and remedy failures in system parts) without the need for physical visits to the customer premises;

2) It allows system to detect telemetry capable cable access units;

3) It allows telemetry functionality to be disabled on cable access units when incompatible software is loaded; and

4) there is no power dissipation when the cable access unit 110 is not premise powered (and is otherwise powered such as by line-power via coaxial cable or the like).

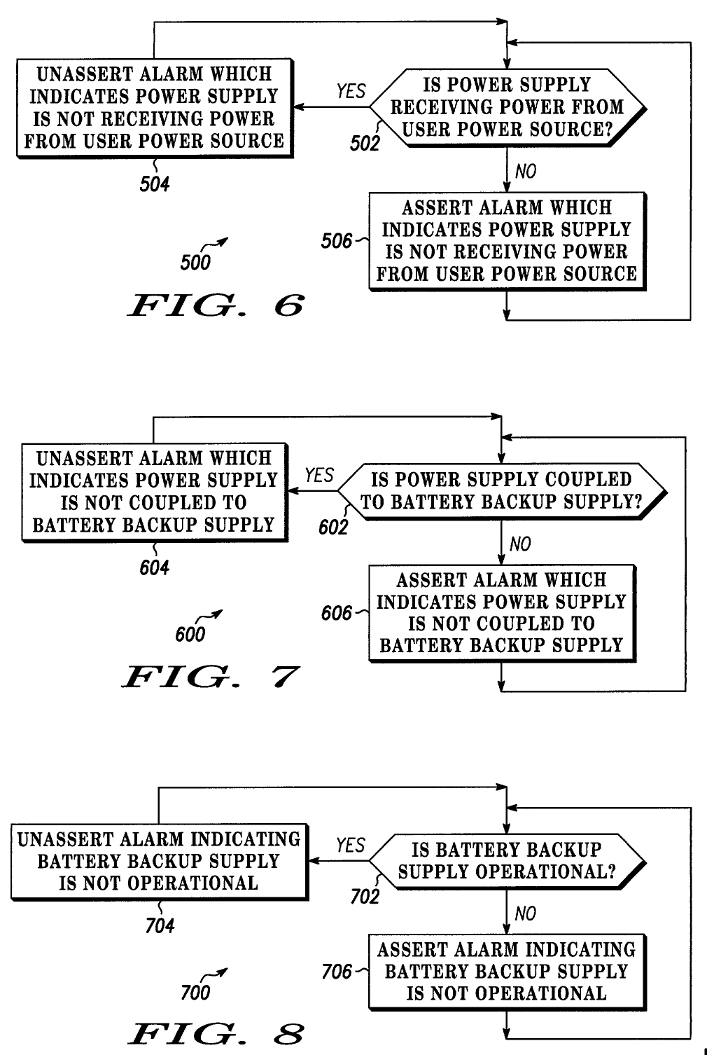

FIGS. 6-8 show three algorithms according to one embodiment for the detection of the backup power supply 120 status and assertion of the detected status by the main power supply 116. In this embodiment, the algorithms begin when the cable access unit 110 is initially powered up and continue by either a continuous or periodic basis as long as the cable access unit 110 is powered.

Referring to FIG. 6, shown is an exemplary algorithm 500 of one embodiment for asserting an on-battery power supply alarm. The algorithm 500 operates as a continuous loop checking whether or not the backup power supply 120 is supplying power to the cable access unit 110 and ensures the correct alarm condition is asserted at the correct alarm address.

In this embodiment, algorithm 500 executes in the main power supply 116. Alternatively, algorithm 500 could execute in the backup power supply 120. Further to this embodiment, algorithm 500 is hardware encoded, but can alternatively be implemented in software or a hardware/software hybrid. The algorithm 500 begins by checking 502 whether the power supply is receiving power from the commercial power source. If the power supply is receiving power from the commercial power source, the algorithm 500 deasserts 504 the alarm condition. If the power supply is not receiving power from the commercial power source, the algorithm 500 asserts 506 the alarm condition. In either event, the algorithm 500 cycles back and checks 502 whether the backup power supply 120 is supplying power to the cable access unit 110 and thereafter continues as discussed previously.

In one hardware embodiment (not shown), the algorithm 500 is implemented as a comparator checking whether or not the backup power supply 120 is supplying power, with the output of the comparator controlling the assertion or deassertion of the alarm condition.

Referring to FIG. 7, shown is a flowchart of an exemplary algorithm 600 of one embodiment for asserting a battery-disconnect power supply alarm. The algorithm 600 operates as a continuous loop checking whether or not the backup power supply 120 is coupled to the main power supply 116 and ensures the correct alarm condition is asserted at the correct alarm address when warranted.

In an embodiment, algorithm 600 runs on the main power supply 116. Alternatively, algorithm 600 can execute in the backup power supply 120. Further to this embodiment, algorithm 600 is hardware encoded, but can alternatively be implemented in software or a hardware/software hybrid. The algorithm 600 determines 602 whether the backup power supply 120 is coupled to the main power supply 116. If the battery backup supply is coupled to the main power supply 116, the algorithm 600 deasserts 604 any alarm. If the battery backup supply 120 is not coupled to the main power supply 116, the algorithm 600 asserts 606 the alarm condition. In either event, the algorithm 600 cycles back and again determines 602 and thereafter continues as discussed before.

In a hardware embodiment (not shown), the algorithm 600 would be implemented as a comparator checking whether or not the backup power supply 120 is coupled to the main power supply 116 by continuously testing the presence of a backup power supply signal, with the output of the comparator controlling the assertion or deassertion of the alarm condition.

Referring to FIG. 8, shown is a flowchart of an exemplary algorithm of one embodiment for asserting a power supply alarm. The algorithm 700 operates as a continuous loop checking whether or not the backup power supply 120 is operational (i.e. not failed) and ensures the correct alarm condition is asserted at the correct alarm address when warranted.

In this embodiment, algorithm 700 runs on the main power supply 116. Alternatively, algorithm 700 could execute in the backup power supply 120. Further to this embodiment, algorithm 700 is hardware encoded, but can alternatively be implemented in software or a hardware/software hybrid. The algorithm 700 determines 702 whether the backup power supply 120 is operational. If the battery backup supply is operational, the algorithm 700 deasserts 704 any alarm condition indicating the backup supply is non-operational. If the battery backup supply is not operational, the algorithm 700 asserts 706 an alarm condition. In either event, the algorithm 700 cycles back, determines 702 whether the backup power supply 120 is operational or not, and continues as discussed previously.

In a hardware embodiment (not shown), the algorithm 700 would be implemented as a comparator checking whether or not the backup power supply 120 is operational by testing the supply voltage available from the backup power supply 120, with the output of the comparator controlling the assertion or deassertion of the alarm condition. Alternatively, other tests could be used such as periodically testing the current drive capability of the backup power supply 120.

While a basic integrated cable services network is used herein by way of example, this is only one embodiment and is not limiting to the present invention. The present invention is equally applicable to systems such as, but not limited to, voice over internet protocol (VoIP) embedded media terminal adaptor (EMTA); wireless linked loop (WLL); telephony remote terminals; cable telephony platforms on which broadband operators can deliver voice, data, and/or video over a common hybrid fiber/coax (HFC) network such as Motorola's CableComm system; integrated services digital network (ISDN) embedded media terminal adaptor (EMTA); data over cable service interface specification (DOCSIS); European DOCSIS (EuroDOCSIS); or digital video broadcasting (DVB).

It is understood that, while this description is specific to device access in integrated cable access networks, the present invention can be applied in any communications or computer network or system. Additionally, the algorithms of the present invention may be implemented in hardware-only configurations and in hardware plus software configurations.

The present invention has been described in terms of various embodiments, however, it is understood that numerous additional advantages and modifications will readily occur to those skilled in the art. Therefore, the invention in its broader aspects is not limited to the specific details and representative embodiments shown and described herein. Accordingly, various modifications may be made of the general inventive concept without departing from the spirit or scope of the appended claims and their equivalents.

We claim:

1. A communications system comprising:
a communication distribution network;
a plurality of communication cable access units coupled to the communication distribution network, at least one of the cable access units each receiving power from a respective power supply powered by a main power source, said power supply including a backup power source adapted to supply power to an associated cable access unit when the main power source fails, said power supply further adapted to generate status information on the backup power source, at least one of the cable access units adapted to monitor the status information generated by said respective power supply and to check and record the capability of the cable access unit to acquire said status information;
an operator unit coupled to said network, said operator unit adapted to monitor, for at least one of the cable access units, the capability of the cable access unit to check and record said status information and also the backup power source status information via two-way communication with said cable access unit; and
a user interface coupled to said operator unit, and said operator unit adapted to display an indication of the monitored status information on said user interface.

2. A system as claimed in claim 1, wherein the power supply is further adapted to generate said status information on the backup power source wherein said status information generated is selected from at least one of backup power source on information, backup power source missing information, and backup power source needing replacement information.

3. A system as claimed in claim 2, wherein said operator unit is further adapted to generate an alarm message, including an identification of the associated cable access unit, on the user interface when status information on the backup power source is received from said associated cable access unit indicating a backup power source on condition detected at the monitored cable access unit.

4. A system as claimed in claim 2, wherein said operator unit is further adapted to generate an alarm message, including an identification of the associated cable access unit, on the user interface when status information on the backup power source is received from said associated cable access unit indicating at least one of a backup power source on, a backup power source missing, and a backup power source needing replacement condition detected at the monitored cable access unit.

5. A system as claimed in claim 4, wherein the operator unit is further adapted to monitor backup power source status information from a plurality of cable access units located at respective different subscriber premises.

6. A system as claimed in claim 5, wherein the operator unit is further adapted to maintain at least a partial count of the number of cable access units respectively reporting a backup power source on condition within a predetermined service area.

7. A system as claimed in claim 6, wherein the operator unit is further adapted to display on the user interface a generalized indication of a service area wide warning condition in lieu of individualized indications for each cable access unit when the count of the number of cable access units reporting a backup power source on condition exceeds a predetermined value.

8. A system as claimed in claim 4, wherein said backup power supply is a secondary alternating current power feed.

9. A system as claimed in claim 4, wherein said backup power supply is a generator.

10. A system as claimed in claim 4, wherein said backup power supply is a fuel cell.

11. A system as claimed in claim 4, wherein said backup power supply is a solar cell.

12. A system as claimed in claim 4, wherein said backup power supply is a battery.

13. A system as claimed in claim 1, wherein the cable access unit further comprises a hardware unit adapted to detect the status information from the power supply, and a processor unit adapted to check whether the cable access unit can acquire the backup power source status information and to receive the status information from the hardware unit when acquired and also report said status information back to said operator unit via said network responsive to a request from said operator unit for such status information when received at the cable access unit.

14. A system as claimed in claim 1, further comprising at least one user device coupled to the cable access unit and adapted to receive at least one of communications and data over the network via the cable access unit.

15. A system as claimed in claim 14, wherein the at least one user device comprises a phone unit, a television, an answering machine, and a computer.

16. A method of remotely sensing the power supply states of communication cable access units coupled to a communications network, comprising:
operably coupling a plurality of communication cable access units to a communication network, the cable access units each coupled to a respective power supply powered by a main power source, and said power supply having a backup battery adapted to supply backup power to an associated cable access unit when the main power source fails;
monitoring power supply status information from at least one of the cable access units by:
generating a status information signal by the power supply associated with the cable access unit to be monitored indicating at least one of the presence of the backup battery and the power status of the backup battery when the main power fails,
obtaining, at the cable access unit, access information on whether the cable access unit is capable of obtaining the status information on the backup battery, and when so capable, acquiring said status information on the backup battery,
transmitting, from an operator unit to the cable access unit via the network, a request for the access information and status information from the cable access unit for transmission back to the operator unit via said network,
sending the access information back to the operator unit from the cable access unit via the network, and including the status information when the access information indicates the cable access unit is status information collection capable,
processing, at the operator unit, said access information, and also said status information when the access information indicates the cable access unit is status information collection capable, and
displaying an indication of the respective battery status information for an associated cable access unit on a user interface coupled to the operator unit.

17. A method as claimed in claim 16, further comprising generating status information by the power supply on the backup battery selected from at least one of backup battery on information, backup battery missing information, and backup battery needing replacement information.

18. A method as claimed in claim 17, further comprising generating by the operator unit an alarm message, including an identification of the associated cable access unit, on the user interface when status information on the backup battery as received from said cable access unit indicates at least one of a backup battery on, a backup battery missing, and a backup battery needing replacement condition for the monitored cable access unit.

19. A method as claimed in claim 18, further comprising acquiring backup battery status information from a plurality of cable access units located at respective different subscriber premises, and simultaneously displaying, on the user interface, individualized indications of the respective battery status conditions associated with the respective cable access units.

20. A method as claimed in claim 19, further comprising maintaining a count of the number of cable access units reporting a backup battery on condition within a predetermined service area.

21. A method as claimed in claim 20, further comprising displaying a generalized indication on the user interface of a service area wide warning condition in lieu of individualized indications for each cable access unit when the count of the number of cable access units reporting a backup battery on condition within the predetermined service area exceeds a predetermined value.

22. A method as claimed in claim 16, wherein said acquiring of the status information on the backup battery includes providing a hardware unit detecting and receiving the status information from the power supply, and providing a processor unit checking to determine whether the cable access unit can acquire the backup battery status information via the hardware unit, and when acquired, said processor unit retaining said status information until said request is received at the cable access unit from the operator unit.

23. A method as claimed in claim 16, wherein said obtaining of status information on the backup battery is performed on a periodic basis.

24. A method as claimed in claim 16, further comprising at least one user device coupled to the cable access unit and adapted to receive at least one of communications and data over the network via said cable access unit in which the user device is one of a phone unit, a television, an answering machine, and a computer.

25. An access unit for use in a communications network comprising:
processing circuitry having a first input, a first output, a second input, and a second output, said processing circuitry first input operably coupled to an operator unit to receive a power supply status query, said processing circuitry first output operably coupled to said operator unit to provide a power supply status thereto; and
a detection unit having a first input coupled to said processing circuitry second output to receive power supply status requests, said detection unit having a second input operably coupled to a power supply to monitor status of said power supply, said detection unit having a status output coupled to said processing circuitry second input to provide a monitored power supply status thereto.

26. A system for remote sensing of power supply states, said system comprising:
a communications network;
a power supply located at or near a customer's premises, said power supply powered by a power source, said power supply having a backup power supply, said power supply generating one or more power supply status indications;
a cable access unit coupled to said power supply, said cable access unit coupled to said network, said cable access unit powered by said power supply, said cable access unit monitoring one or more of said generated power supply status indications;
an operator unit coupled to said network, said operator unit communicating with said cable access unit to ascertain at least one of said monitored power supply indications; and
a user interface coupled to said operator unit, said operator unit displaying on said user interface an indication of at least one of said ascertained power supply indications.

27. A system as in claim 26, wherein said one or more generated power supply indications is selected from one or more of backup-on, backup-missing, and backup-replace.

28. A system as in claim 27, wherein said communication by said operator unit is carried out in a periodic manner.

29. A system as in claim 28, wherein said periodic communication is carried out by pinging.

30. A system as in claim 29, wherein said backup-on power supply indication is generated in response to said backup power supply providing power to said cable access unit.

31. A system as in claim 30, wherein said backup-missing power supply indication is generated in response to said power supply no longer being coupled to said backup power supply.

32. A system as in claim 31, wherein said backup-replace power supply indication is generated in response to said battery backup supply being in a non-operational state.

33. A system as in claim 29, wherein said backup-missing power supply indication is generated in response to said power supply no longer being coupled to said backup power supply.

34. A system as in claim 29, wherein said backup-replace power supply indication is generated in response to said battery backup supply being in a non-operational state.

35. A method for remote sensing and display by an operator unit of power supply states of power supplies each having a respective backup power supply, each of said power supplies coupled to a respective cable access unit, each of said cable access units coupled to said operator unit, said operator unit coupled to a storage location, each of said power supplies powered by a respective power source, said method comprising:
a) generating, by at least one of said power supplies, a respective power supply status in response to the occurrence of at least one predetermined condition associated with said respective backup power supply;
b) monitoring, by at least one of said cable access units, the power supply status of the respective power supply;
c) reading from said storage location, by said operator unit, identifiers of at least one alarm condition and addresses of at least one of said cable access units to be monitored;
d) communicating with said one or more cable access units by said operator unit to ascertain the power supply status of said respective power supplies;
e) analyzing one or more of said communicated power supply statuses to determine whether any alarm conditions have been generated by said power supplies; and
f) displaying by said operator unit, responsive to said analyzing indicating at least one alarm conditions have been generated, an indication of at least one alarm conditions and the respective generating power supply on a user interface associated with said operator unit.

36. A method as in claim 35, wherein said at least one predetermined condition includes the condition where said backup power supply is suppling power to said respective cable access unit.

37. A method as in claim 35, wherein said at least one predetermined condition includes the condition where said backup power supply is determined to be disconnected from said respective power supply.

38. A method as in claim 35, wherein said at least one predetermined condition includes the condition where said backup power supply is determined to need replacement.

39. A method as in claim 35, wherein said step (d) of communicating comprises the steps of:
i) pinging, by said operator unit, said at least one cable access units, and
ii) receiving, by said operator unit, a response indicating whether any of said at least one alarm condition have been generated.

40. A method as in claim 39, wherein said at least one predetermined condition includes the condition where said backup power supply is suppling power to said respective cable access unit.

41. A method as in claim 39, wherein said at least one predetermined condition includes the condition where said backup power supply is determined to be disconnected from said respective power supply.

42. A method as in claim 39, wherein said at least one predetermined condition includes the condition where said backup power supply is determined to need replacement.

43. A computer program product for providing an indication on a user interface of alarm conditions of power supplies, said power supplies each having a backup power supply, said power supplies each coupled to a cable access unit, said cable access units coupled to an operator unit, said operator unit coupled to said user interface, said computer program product comprising a computer usable medium having a computer readable code thereon, said computer readable program code comprising:
computer readable program code means for generating, by one or more of said power supplies, alarm conditions in respective alarm locations when respective predetermined events occur;
computer readable program code means for monitoring, by one or more of said cable access units, respective ones of said power supplies to determine whether any said alarm conditions have been generated;
computer readable program code means for reading from a storage location, by said operator unit, identifiers of one or more said cable access units;
computer readable program code means for communicating with said identified cable access units by said operator unit to determine whether any of said identified cable access units indicate any of said alarm conditions have been generated; and
computer readable program code means for displaying by said operator unit, responsive to said communication, indications of said any generated alarm conditions and corresponding indicating said identified cable access unit on a user interface associated with said operator unit.

44. A computer program product as in claim 43, wherein said computer readable program code means for monitoring comprises:
computer readable program code means for pinging, by said operator unit, said cable access unit, and
computer readable program code means for receiving, by said operator unit, a response indicating said alarm condition has been generated.

45. A computer program product as in claim 44, wherein said computer readable program code means for generating comprises:
computer readable program code means for determining, by said power supply, whether said power supply is receiving power from said customer power supply, and
computer readable program code means for asserting, by said power supply, a first alarm condition by generating a first signal at a first location in response to said determination indicating said power supply is not receiving power from said customer power supply.

46. A computer program product as in claim 44, wherein said computer readable program code means for generating comprises:
computer readable program code means for determining, by said power supply, whether said power supply is uncoupled from said battery backup supply, and
computer readable program code means for asserting, by said power supply, a second alarm condition by generating a second signal at a second location in response to said determination indicating said power supply is not coupled to said battery backup supply.

47. A computer program product as in claim 44, wherein said computer readable program code means for generating comprises:
computer readable program code means for determining, by said power supply, whether said battery backup supply is non-operational, and
computer readable program code means for asserting, by said power supply, a third alarm condition by generating a third signal at a third location in response to said determination indicating said power supply is not receiving power from said customer power supply.

48. An operator unit for use in a network comprising:
a control query output adapted to be operably coupled to one or more access units in said network, said control query output to provide power supply status queries to said one or more access units;
an analyzation unit having a status reply input adapted to be operably coupled to said one or more access units, said status reply input to receive power supply status reply messages from said one or more access units, said analyzation unit having an output to provide notice of any asserted alarm conditions; and
an operator interface having an input coupled to said analyzation unit output; said operator interface having an output to provide an alarm condition warning.

49. An operator unit as in claim 48, wherein said operator interface output is one or more of a visual display, a speaker, and a tactile feedback device.

50. An operator unit as in claim 49, said operator unit further comprising:
a counting unit having an input coupled to said analyzation unit output and an output to provide at least a partial count of the number of access units asserting an alarm condition, said operator interface having a count input coupled to said counting unit output, said operator interface warning output to provide at least one of an individual alarm condition warning and a multiple-access unit alarm condition warning.

51. An operator unit as in claim 49 said operator unit further comprising:
a counting unit having an input coupled to said analyzation unit output and an output to provide at least a partial count of the number of access units asserting an alarm condition
a gauge unit having an input coupled to said counting unit output and an output to provide a service-area wide alarm condition warning when said count equals or exceeds a predetermined count threshold, said gauge unit output coupled to said operator unit input, said operator interface warning output to provide at least one of an individual alarm condition warning and a multiple-access unit alarm condition warning.

52. An operator unit as in claim 49, wherein said alarm condition warning includes an identification of the associated access unit and at least one of a battery-on, a battery-missing, and a battery-failed alarm condition.
